(19) United States
(12) Patent Application Publication
(10) Pub. No.: US 2007/0267502 A1
(43) Pub. Date: Nov. 22, 2007

(54) Data cards having multiple machine readable strips

(75) Inventors: Samuel Zellner, Dunwoody, GA (US); Elizabeth Wagner, Atlanta, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/435,910

(22) Filed: May 17, 2006

(51) Int. Cl. G06K 19/00; G06K 19/06

(52) U.S. Cl. 235/487; 235/493

(57) ABSTRACT

Data cards have multiple machine readable strips to facilitate the swiping of the card in a card reader. A data card may have two or more machine readable strips on one side or one or more machine readable strips on one side and one or more machine readable strips on the opposite side. Where two machine readable strips are on one side with one on the top of the side and one on the bottom of the side, then regardless of whether the top or bottom of the side is present at the reader, the swipe of the card will be successful. Where a machine readable strip is on each side of the card, then regardless of which side faces the reader, the swipe of the card will be successful so long as the machine readable strip of the side facing the reader is present. Where both sides of the card have machine readable strips at both the top and the bottom of each side, then top or bottom of either side may face the reader and result in a successful swipe.

### TECHNICAL FIELD

The present invention is related to data cards such as credit, debit cards, access cards, and other cards carrying some form of data. More particularly, the present invention is related to data cards that have multiple machine readable strips.

### BACKGROUND

Data cards such as credit cards, debit cards, and access cards (e.g., hotel room key card) are associated with an account number or other data of the card holder. In the case of a credit or debit card, the account number is typically present on the card as visible numerals on the card and is also encoded on a machine readable strip on the card, such as a magnetic strip or a bar code strip. To eliminate the need to manually enter the account number or other data when a transaction or access attempt is occurring, the card may be swiped through a card reader that detects the encoded account number or other data from the machine readable strip.

Conventionally, data cards have only a single machine readable strip that is usually located on the top portion of the back side of the data card. Card readers typically require that the data card be oriented in one specific way when being swiped such that the machine readable strip is directly adjacent a sensor of the card reader. Because the data card can be oriented at least four different ways, the user must pay careful attention to how the data card must be oriented for a given card reader. If the data card is swiped while incorrectly oriented, the data card must be re-oriented to one of the at least three other orientations and then swiped again. This must be repeated until the correct orientation is found so that the swipe is successful. This can be bothersome to users of the data card.

### SUMMARY

Embodiments of the present invention address these and other issues by providing multiple machine readable strips on the data card, where each machine readable strip having the same account number or other data encoded thereon or may have different account numbers or other data from one strip to the next. Multiple strips on the single card allow for more than one of the at least four orientations to result in a successful swipe of an account number or other data.

One embodiment is a data card that includes a sheet of material having a first side and a second side. At least one machine readable strip with a first data capacity is located on the first side, and at least one machine readable strip with a second data capacity different than the first data capacity is located on the second side.

Another embodiment is a data card that includes a sheet of material having a first side and a second side. At least two machine readable strips are located on the first side with a first machine readable strip having a first data capacity and a second machine readable strip having a second data capacity different than the first.

Another embodiment is a data card that includes a sheet of material having a first side and a second side. At least two machine readable strips are located on opposite ends of the first side, and at least two machine readable strips are located on opposite ends of the second side, wherein the at least two machine readable strips of the first side and the at least two machine readable strips of the second side have a same data encoded therein, and wherein a first machine readable strip of the first side has a direction of encoding that is opposite a direction of encoding of a second machine readable strip of the first side and a first machine readable strip of the second side and that is the same direction of encoding as a second machine readable strip of the second side.

### DESCRIPTION OF THE DRAWINGS

FIG. 1 shows a front side of one example of a data card having a machine readable strip.

FIG. 2 shows a back side of the data card of FIG. 1 having a machine readable strip.

FIG. 3 shows a front side of one example of a data card having two machine readable strips.

FIG. 4 shows a back side of the data card of FIG. 3 having two machine readable strips.

FIG. 5 shows a perspective view of a card reader requiring the data card to have the machine readable strip in a specific location.

FIG. 6 shows a back side of the data card of FIG. 3 having two machine readable strips of different physical dimensions and resulting data capacities.

### DETAILED DESCRIPTION

Embodiments of the present invention provide data cards with multiple machine readable strips, such as strips on both sides and/or multiple strips on a single side. Accordingly, the card may be oriented in more than one way when being swiped.

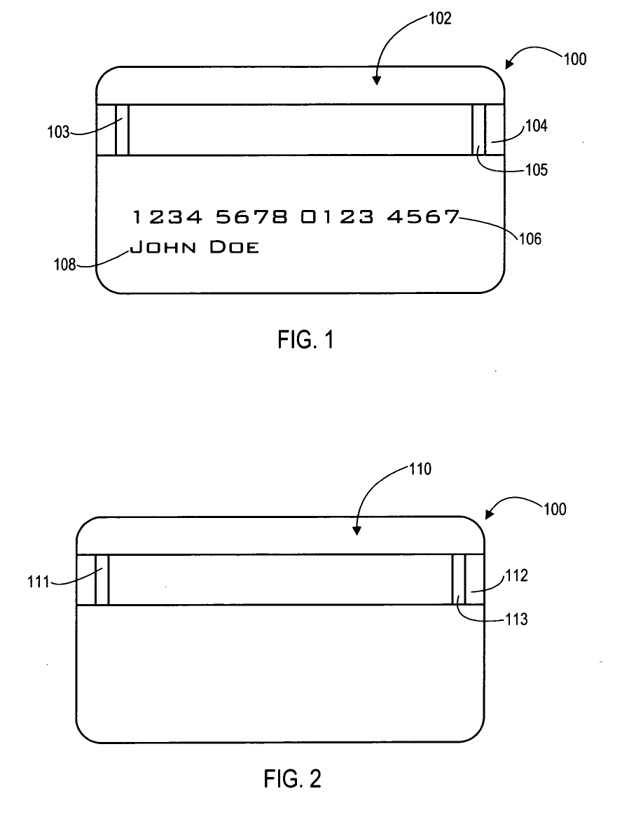

FIG. 1 shows a front side 102 of one example of a data card 100. The data card 100 is formed of a material such as plastic like that of conventional data cards. The data card 100 includes a machine readable strip 104, such as a magnetic strip or a bar code strip, on the front side 102. As shown, the machine readable strip 104 is located at a top portion of the front side 102. However, it will be appreciated that the machine readable strip 104 could be located elsewhere, such as along a bottom portion, so long as the machine readable strip is the proper distance from an edge in accordance with requirements of card readers. Furthermore, as discussed below for other examples, additional machine readable strips may be located on the front side.

Additionally, in this exemplary embodiment, the front side 102 of this example includes numerals 106 making up the account number of the card holder, such as an account number representing a credit account or a debit account. It will be appreciated that for data cards, the account number of other data stored on the machine readable strip of the card may not be shown visibly on the card. Also, in this example the front side 102 has the name 108 of the card holder in visible letters. In certain embodiments where the account number or other data is shown visibly, the numerals 106 and name 108 may be printed as opposed to being raised characters to avoid raised characters from interfering with the card 102 being swiped within the reader.

In this example, the machine readable strip 104 has encoded upon it the account number represented by the visible numerals 106. The machine readable strip 104 has the account number encoded thereon in accordance with requirements of the card reader for the encoding, as is done with the single machine readable strip on the back side of conventional data cards. Such requirements may be that the encoded numbers are to be read from first to last in a left to right manner or in the reverse. For example, there may be a direction of encoding for the machine readable strip 104 such that the beginning digit of the account number is encoded at location 103 while the last digit of the account number is encoded at location 105. Additionally, the machine readable strip 104 is affixed to the data card 100 in the same manner that the single machine readable strip is attached to the back of conventional data cards.

Because the front side 102 has a machine readable strip 104, if the front side 104 faces the sensor of a card reader, then the swipe will be successful so long as the machine readable strip 104 is adjacent the sensor. Therefore, so long as the back side also has a machine readable strip, a user will not be burdened with having to determine which side of the card reader the front side 102 of the data card 100 must face in order to achieve a successful swipe.

FIG. 2 shows a back side 110 of the data card 100. In this example, the back side 110 also has a machine readable strip 112, such as a magnetic strip or a bar code strip, located along a top portion of the back side 110. However, it will be appreciated that the machine readable strip 112 could be located elsewhere, such as along a bottom portion, so long as the machine readable strip is the proper distance from an edge in accordance with requirements of card readers. Like the machine readable strip 104 of the front side 102, this machine readable strip 112 has the account number or other data encoded thereon in accordance with requirements of the card reader for the encoding as is done with the single machine readable strip on the back side of conventional data cards. Additionally, the machine readable strip 112 is affixed to the data card 100 in the same manner that the single machine readable strip is attached to the back of conventional data cards. As discussed above, because both the front side 102 and the back side 110 of the data card 100 both have machine readable strips 104, 112, it does not matter whether the front side 102 or the back side 110 faces the sensor of the card reader such that the difficulty in properly swiping the card is reduced.

A direction of encoding may be provided for the machine readable strip 112 that is the opposite of that of the machine readable strip 104 where the machine readable strips are both along the top side (as shown in FIGS. 1 and 2) or are both along the bottom side. In certain embodiments such as where the same account number or other data is found in both strips, the encoding is opposite in that the side of the card where the encoding of strip 104 starts is the side of the card where the encoding of strip 112 ends. As shown in FIG. 2, the encoding starts at location 111 and ends at location 113, where location 111 is located on the same side of the card as location 105 of FIG. 1 and location 113 is located on the same side of the card as location 103. With the opposite direction of encoding, the reader can properly read the account number or other data from either machine readable strip even where the machine reader requires the swipe to have a specific direction.

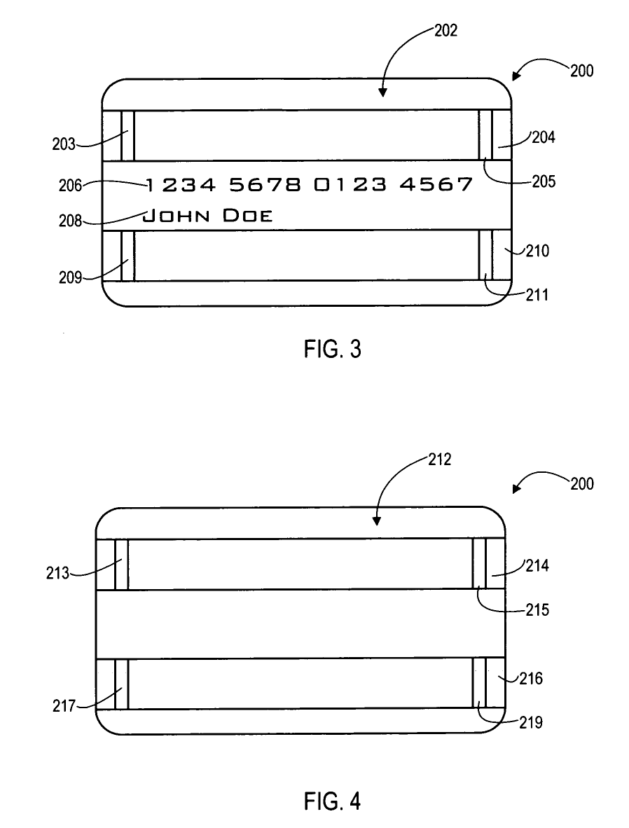

FIG. 3 shows a front side 202 of another example of a data card 200. The data card 200 is formed of a material such as plastic like that of conventional data cards. The data card 200 includes a machine readable strip 204 on the front side 202 at a top portion of the front side 202. Additionally, data card 200 has another machine readable strip 210 along a bottom portion. These machine readable strips 204, 210 are positioned a proper distance from an edge in accordance with requirements of card readers.

Additionally, the front side 202 of this example includes numerals 206 making up the account number of the card holder. Also, in this example the front side 202 has the name 208 of the card holder in visible letters. In this example, the visible numbers 206 and name 208 have been positioned closer to the middle of the data card 200 to allow for placement of the second machine readable strip 210.

According to certain exemplary embodiments, the machine readable strips 204, 210 both have encoded upon them the account number or other data represented by the visible numerals 206. The machine readable strips 204 and 202 have the account number or other data encoded thereon in accordance with requirements of the card reader for the encoding, as is done with the single machine readable strip on the back side of conventional data cards. Additionally, both of the machine readable strips 204, 210 are affixed to the data card 200 in the same manner that the single machine readable strip is attached to the back of conventional data cards.

A direction of encoding may be provided for the machine readable strip 204 that is the opposite of that of the machine readable strip 210. The encoding is opposite in that the side of the card where the encoding of strip 204 starts is the side of the card where the encoding of strip 210 ends. As shown in FIG. 3, the encoding starts at location 203 for strip 204 and starts at location 211 for strip 210. Likewise, the encoding ends at location 205 for strip 204 and ends at location 209 for strip 210. Location 203 is located on the same side of the card as location 209 while location 205 is located on the same side of the card as location 211. With the opposite direction of encoding, the reader can properly read the account number from either machine readable strip even where the machine reader requires the swipe to have a specific direction.

Because the front side 202 has both machine readable strips 204, 212, if the front side 104 faces the sensor of a card reader, then the swipe will be successful regardless of whether the top portion and strip 204 or bottom portion and strip 210 is adjacent the sensor. Thus, the user is not burdened with determining whether the top portion or the bottom portion should be positioned adjacent the sensor when swiping the card. Furthermore, so long as the back side also has at least one machine readable strip, a user will not be burdened with having to determine which side of the card reader the front side 202 of the data card 200 must face in order to achieve a successful swipe.

FIG. 4 shows a back side 212 of the data card 200. In this example, the back side 212 also has two machine readable strips 214, 216. Strip 214 is located along a top portion of the back side 110 while strip 216 is located along a bottom portion. These machine readable strips 214, 216 are positioned a proper distance from an edge in accordance with requirements of card readers. Like the machine readable strips 204, 210 of the front side 202, these machine readable strips 214, 216 have the account number encoded thereon in accordance with requirements of the card reader for the encoding as is done with the single machine readable strip on the back side of conventional data cards. Additionally, these machine readable strips 214, 216 are affixed to the data card 200 in the same manner that the single machine readable strip is attached to the back of conventional data cards. Because both the front side 202 and the back side 212 of the data card 200 both have machine readable strips 204, 210 and 214, 216, it does not matter whether the front side 202 or the back side 212 faces the sensor of the card reader nor does it matter whether the top portion or the bottom portion is adjacent the sensor such that the difficulty in properly swiping the card is further reduced or eliminated altogether.

A direction of encoding may be provided for the machine readable strip 214 that is the opposite of that of the machine readable strip 216. The encoding is opposite in that the side of the card where the encoding of strip 214 starts is the side of the card where the encoding of strip 216 ends. As shown in FIG. 4, the encoding starts at location 213 for strip 214 and starts at location 219 for strip 216. Likewise, the encoding ends at location 215 for strip 214 and ends at location 217 for strip 216. Location 213 is located on the same side of the card as location 217 while location 215 is located on the same side of the card as location 219. With the opposite direction of encoding, the reader can properly read the account number or other data from either machine readable strip even where the machine reader requires the swipe to have a specific direction.

Furthermore, the direction of encoding may be opposite between strips 204 and 214, both along the top side, and may be opposite between strips 210 and 216, both along the bottom side. In doing so, the direction of encoding is the same between strips 204 and 216 and between strips 210 and 214. Accordingly, regardless of the top-to-bottom and the front-to-back side orientation of the card, the reader can properly read the account number or other data from any of the four machine readable strips even where the machine reader requires the swipe to have a specific direction.

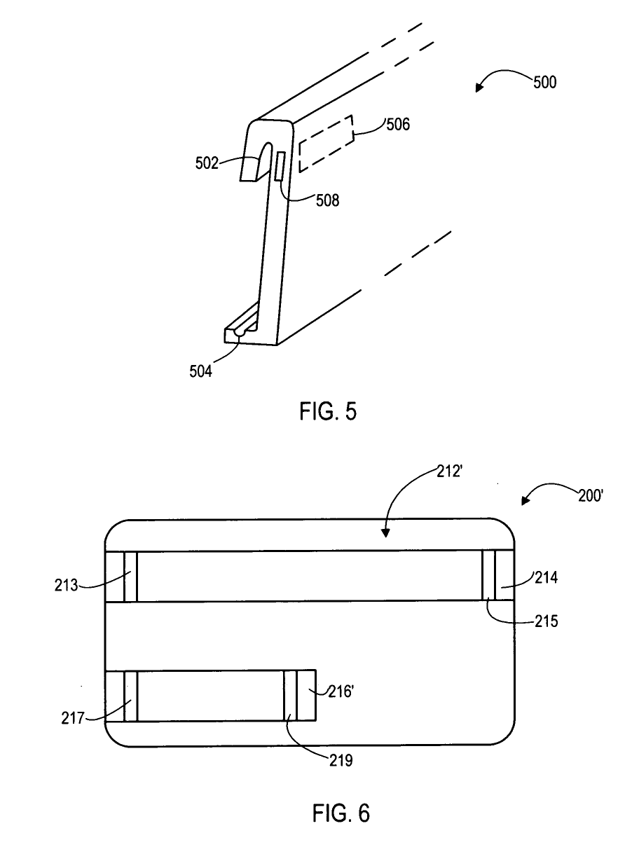

FIG. 5 shows a perspective view of one example of a conventional card reader 500 that requires a machine readable strip to be in a specific location when a card is being swiped. The card reader 500 has grooves 502 and 504 that accept the top and bottom edges of the data card and guide the card as it is being swiped. The card reader 500 also has a sensor 506, such as a magnetic sensor for magnetic strips or an optical sensor for bar code strips. The card reader 500 may also have a swipe indicator 508, such as a light emitting diode (LED).

When a data card is inserted, if the machine readable strip is not facing the sensor 506, either because it is on the bottom instead of the top or because it is facing to the opposite side of groove 502, then the swipe will be unsuccessful and the indicator 508 will indicate so such as by not emitting light or by emitting a color of light that represents a failed swipe. However, when the user inserts a card with a strip on a top portion of either side, such as shown in FIGS. 1 and 2, then the sensor 506 will detect either strip 104 or strip 112 so long as the top portion of the card is located in groove 502.

When the user inserts a card with a strip on both the top portion and the bottom portion of the same side, such as shown in FIG. 3, then the sensor 506 will detect either strip 204 or 210 so long as the front side 202 is facing the sensor 506. When the user inserts a card with a strip on both the top portion and the bottom portion of both sides, such as shown in FIGS. 3 and 4, then the sensor 506 will detect either strips 204, 210, 214, or 216 such that the user does not need to pay attention to the orientation of the data card when swiping it. Furthermore, with the direction of encoding between the strips following the examples above of FIGS. 1-4, the sensor 506 will correctly detect the account number from either strips 204, 210, 214, or 216 even when the sensor requires a specific swiping direction.

When the user successfully swipes the card, the indicator 508 may indicate so by emitting a particular color of light. Utilizing one of the embodiments disclosed above, the user is more likely or even certain to successfully swipe the transaction card on the first try, thereby increasing the level of satisfaction the user has when using the data card.

While providing the card user with the convenience of having multiple card orientations that will properly swipe is one valid reason for including multiple strips, another reason involves including additional and/or different data from one strip to the next. For example, one strip might contain a credit account number, another strip may contain a debit account number, yet another strip may provide access through a doorway, while another strip provides an identity of the user and/or medical data of the user.

Regarding the exemplary embodiments discussed above, the plurality of strips of a single data card may thus have varying data capacities as the amount of information included on one strip versus another may vary. The necessary capacity of a strip that holds only a credit account number is much less than the necessary capacity of a strip that holds the name, address, telephone number, other identifying information, medical information, and so forth of the card user.

The difference in capacity from one strip to the next may be due to various characteristics of the strip. For example, the data capacity of one strip may be a result of the recording medium being a low density medium, standard density medium, or high density medium, a single dimension bar code versus a multi-dimensional block code, and so forth. Thus, strips of a single card may vary in density or dimensionality to result in different data capacities.

As another example, the data capacity of the strip may be a result of the physical dimensions of the strip, where the data containing portion of one strip may be greater in length along the direction of encoding relative to a data containing portion of another strip of the same card such that they have a different data capacity. An example of this is shown in FIG. 6 where back side 212′ of card 200′ has multiple strips 214 and 216′. Here the strip 216′ is shorter than the strip 214, and shorter than the strip 216 of FIG. 4. Thus, the strip 216′ has a lesser data capacity than strip 214 while strip 216 of FIG. 4 may have the same data capacity as strip 214. The space left blank by the shorter strip 216′ may be used for other purposes.

Exemplary embodiments of data cards may have multiple strips to provide convenience to the user. The card may be encoded so that the necessary data for a swipe may be found for multiple orientations of the card, such as where the same data is encoded but in various directions of encoding that account for the direction of swiping. Furthermore, the card may be encoded to contain various sets of data from one strip to the next so that data otherwise requiring multiple cards is consolidated to a single card.

While the invention has been particularly shown and described with reference to various embodiments thereof, it will be understood by those skilled in the art that various other changes in the form and details may be made therein without departing from the spirit and scope of the invention.

1. A data card, comprising:
a sheet of material having a first side and a second side;
at least one machine readable strip with a first data density on the first side; and
at least one machine readable strip with a second data density different than the first data density on the second side.

2. The data card of claim 1, wherein the at least one machine readable strip on the first side and the at least one machine readable strip on the second side are encoded with numbers representing a credit account.

3. The data card of claim 1, wherein the at least one machine readable strip on the first side and the at least one machine readable strip on the second side are encoded with numbers representing a debit account.

4. The data card of claim 1, wherein the sheet is a plastic.

5. The data card of claim 1, wherein the sheet includes visible characters matching the data encoded on at least one of the machine readable strips.

6. The data card of claim 1, wherein the machine readable strip of the first side and of the second side includes a same data encoded thereon.

7. The data card of claim 6, wherein the direction of encoding of the machine readable strip of the first side is opposite the direction of encoding of the machine readable strip of the second side.

8. A data card, comprising:
a sheet of material having a first side and a second side; and
at least two machine readable strips on the first side with a first machine readable strip having a first data density and a second machine readable strip having a second data density different than the first.

9. The data card of claim 8, wherein the at least two machine readable strips on the first side are encoded with numbers representing a credit account.

10. The data card of claim 8, wherein the at least two machine readable strips on the first side are encoded with numbers representing a debit account.

11. The data card of claim 8, wherein the sheet is a plastic.

12. The data card of claim 8, wherein the sheet includes visible characters matching data encoded on at least one of the machine readable strips.

13. The data card of claim 3, wherein each of the machine readable strips of the first side include a same data encoded thereon, with the direction of the encoding for a first machine readable strip of the first side being opposite a direction of the encoding for a second machine readable strip of the first side.

14. A data card, comprising:
a sheet of material having a first side and a second side;
at least two machine readable strips on opposite ends of the first side, wherein at least one of the machine readable strips has a data density that is different than a data density of the other machine readable strips; and
at least two machine readable strips on opposite ends of the second side, wherein the at least two machine readable strips of the first side and the at least two machine readable strips of the second side have the same data encoded thereon, and wherein a first machine readable strip of the first side has a direction of encoding that is opposite from a direction of encoding of a second machine readable strip of the first side and a first machine readable strip of the second side and that has the same direction of encoding as the second machine readable strip of the first side.

15. The data card of claim 14, wherein the at least two machine readable strips on the first side and the at least two machine readable strips on the second side are encoded with numbers representing a credit account.

16. The data card of claim 14, wherein the at least two machine readable strips on the first side and the at least two machine readable strips on the second side are encoded with numbers representing a debit account.

17. The data card of claim 14, wherein the sheet is a plastic.

18. The data card of claim 14, wherein the sheet includes visible characters matching data encoded on the at least one of the machine readable strips.

19-20. (canceled)
